(19) United States
(12) Patent Application Publication
(10) Pub. No.: US 2015/0154813 A1
(43) Pub. Date: Jun. 4, 2015

(54) METHOD FOR VERIFYING THE AUTHENTICITY OF A SENDER OF A MAIL ITEM

(71) Applicant: Deutsche Post AG, Bonn (DE)

(72) Inventors: Matthias RAKOW, Berlin (DE); Bastian FISCHER, Bonn (DE)

(21) Appl. No.: 14/558,671

(22) Filed: Dec. 2, 2014

(30) Foreign Application Priority Data
Dec. 2, 2013 (DE) 102013113323.1

(51) Int. Cl. G07B 17/04; G07B 17/00

(52) U.S. Cl. CPC G07B 17/04; G07B 17/00467; G07B 2017/00935; G07B 2017/00911; G07B 2017/00895; G06Q 2220/00

(57) ABSTRACT

Systems and methods herein relate to verifying an authentication of a sender of a mail item. Certain implementations may include various steps, such as: the sender applying a machine-readable postage indicium having an embedded electronic seal onto the mail item, the sender electronically transmitting the seal to a logistics service provider, the logistics service provider reading a received seal out of a received postage indicium of the mail item received by the logistics service provider, the recipient detecting a postage indicium of the mail item delivered to the recipient by means of a mobile reading device and transmitting said postage indicium to the logistics service provider, the logistics service provider reading a delivered seal out of the delivered postage indicium, and/or the logistics service provider comparing the delivered seal with the transmitted seal.

### CROSS-REFERENCE TO RELATED APPLICATION INFORMATION

This application claims priority from German Patent Application No. 10 2013 113 323.1, filed Dec. 2, 2013, published as ______, which are incorporated herein by reference in entirety.

The innovations herein relate to methods for verifying authentication of a sender of a mail item, including feature(s) of the sender applying a machine-readable postage indicium having an embedded electronic seal onto the mail item.

Various methods and designs of prepaid postage indicia exist and may be used for the postage prepayment of mail items, such as letters and packages. This has always been fraught with the problem, however, of designing the prepaid postage indicia to be counterfeit-proof since, in a manner analogous to phishing emails in the Internet, first-class mail is being used to an increasing extent to convince a recipient of the first-class mail to believe in a false identity. Mail items having a false sender's identity may be used, for example, to ascribe unauthorized economic advantages to the sender in order to prompt a recipient of the mail item to transfer a sum of money to fake account of a fake sender, or to prompt the recipient of the mail item to provide access data that the fake sender can then use to the disadvantage of the recipient.

Proceeding from this situation, certain problems addressed by the innovations here are to provide methods and systems for checking an authentication of a sender of a mail item such that a recipient of the mail item can readily check the authenticity of the sender in order to determine whether the mail item originated from a safe source and, therefore, whether the mail item and, therefore, the contents of the mail item, are trustworthy, in particular in order to determine whether the mail item has remained undamaged during transport.

Accordingly, certain example innovations include methods and systems for checking an authentication of a sender of a mail item, including steps such as:
a) the sender generating a machine-readable postage indicium by means of a computer-implemented method, the postage indicium being configured as a matrix code, a bar code, a serial shipping container code, a EAN-UPC Code, a ITF-14 code and/or a data matrix code, wherein
an electronic seal, as an electronic secret, and a piece of unambiguous mail item information assigned to the particular mail item are embedded in the postage indicium, and
the electronic seal is designed as an electronic secret encoded with a symmetric key, as a one-time password as electronic secret and/or as a one-time password as electronic secret, which is generated by means of an HMAC-based one-time password algorithm according to RFC 4226,
b) the sender applying and/or printing the machine-readable postage indicium having the embedded electronic seal onto the mail item,
c) the sender electronically transmitting the electronic seal to a logistics service provider by means of an Internet connection,
d) the sender delivering the mail item to the logistics service provider,
e) the logistics service provider reading a received seal out of a received postage indicium of the mail item that was received by the logistics service provider, by means of a first reading device, which is provided as a smartphone, a tablet PC, a laptop, a camera and/or as an application,
f) the logistics service provider comparing the received seal with the transmitted seal, by means of a computer-implemented method,
g) the logistics service provider delivering the mail item to the recipient, provided the comparison carried out according to step f) shows a match,
h) the recipient detecting the delivered postage indicium of the mail item delivered to the recipient, by means of a mobile reading device, which is provided as a smartphone, a tablet PC, a laptop, a camera and/or an application,
i) the recipient transferring a delivered postage indicium, which was detected by the recipient of the mail item by means of the mobile reading device, to the logistics service provider by means of an Internet connection,
j) the logistics service provider reading a delivered seal out of the received, delivered postage indicium by means of a computer-implemented method, and
k) the logistics service provider comparing the delivered seal with the transmitted seal, by means of a computer-implemented method, and/or
l) the logistics service provider electronically transmitting a confirmation of the authenticity of the mail item to the recipient by means of an Internet connection, provided the comparison carried out according to step k) shows a match.

Furthermore, certain example innovative aspects include methods and systems for checking an authentication of a sender of a mail item, including steps such as:
a) the sender applying a machine-readable postage indicium having an embedded electronic seal onto the mail item,
c) the sender electronically transmitting the seal to a logistics service provider,
e) the logistics service provider reading a received seal out of a received postage indicium of the mail item received by the logistics service provider,
i) the recipient detecting a postage indicium of the mail item delivered to the recipient by means of a mobile reading device and transmitting said postage indicium to the logistics service provider,
j) the logistics service provider reading a delivered seal out of the delivered postage indicium, and/or
k) the logistics service provider comparing the delivered seal with the transmitted seal.

According to a preferred development, the method additionally comprises at least one of the following steps of:
a) the sender generating the postage indicium comprising the embedded seal,
d) delivering the mail item to the logistics service provider,
f) the logistics service provider comparing the delivered seal with the transmitted seal,
g) delivering the mail item to the recipient, provided the comparison carried out according to step f) shows a match,
h) the recipient detecting the delivered postage indicium of the mail item delivered to the recipient, by means of the mobile reading device, and/or
l) the logistics service provider electronically transmitting a confirmation of the authenticity of the mail item to the recipient, provided the comparison carried out according to step k) shows a match.

Certain innovative, important aspects of the disclosure here may include a physical mail item being secured with the aid of an externally accessible postage indicium during the entire production process, i.e., starting with the generation of the postage indicium by the sender up to delivery of the mail item to the recipient, such that the recipient can check the authenticity of the sender with the aid of a mobile reading device, such as a smartphone. In such examples, since the sender is known to the logistics service provider by virtue of the fact that, in e), the received signal may be read out by the logistics service provider and was then checked by means of a comparison, the recipient can be certain that the confirmation transmitted in step l) correctly represents the authenticity of the mail item and, therefore, that the identity of the sender may be confirmed.

In other words, in certain innovative examples, the logistics service provider can guarantee, by means of the method according to the invention, that the mail item and, therefore, the contents of the mail item, have been delivered to the recipient in undamaged form from precisely the “correct” sender without the need for any type of additional signature to be provided within the mail item during the production process. As a result, the recipient may be provided with a guarantee, by the logistics service provider, of the origin and of the undamaged state of the contents of the mail item without the logistics service provider itself having to know the contents of the mail item.

Certain important aspects may involve the participation by a trustworthy third party, namely the logistics service provider. Bilateral authenticity checks may include both the sender and the recipient building up their own infrastructure. Certain innovative aspects, which are also a component of implementations herein, may include authentication by virtue of incorporating the logistics service provider or a postal service provider as an entity that is deemed by the recipient to be trustworthy. In such examples, the recipient does not have to increase the technical complexity of the infrastructure in order to authenticate various mail items from various senders, regardless of how many senders participate in the method.

In certain examples, step a), may include, the postage indicium preferably generated as a matrix code and comprises the electronic seal, which may also be referred to as an e-seal. The postage indicium, which may also be referred to as a prepaid postage indicium or a stamp, is preferably generated by means of a computer-implemented method, for example by software and a corresponding printer for applying the postage indicium onto the mail item. The mail item itself can be any number of this, for example, a letter, a postal item, a package, or any other type of transportable good, such as a Euro pallet, etc., The term “machine-readable” preferably means that the postage indicium can be read in an automated manner by a computer means and, therefore, can also be further processed. Further preferably, the electronic seal may be designed as an electronic secret, wherein, even further preferably, the secret is known only to the sender and to the logistics service provider and/or is valid only for a certain mail item in each case.

The examples include configured postage indicium having the embedded electronic seal, which is preferably likewise designed to be machine-readable, is then applied onto the mail item, for example by means of a printing process in step a), the seal is electronically transmitted from the sender to the logistics service provider in step c). The electronic transmission may take place via a data network, a mobile wireless connection, or any other type of method for exchanging electronic information, for example in the form of email. Further, the logistics service provider may store the transmitted seal, for example in a database.

After this, or parallel therewith or before this, the mail item may be delivered to the logistics service provider according to example step d), which can take place by the sender bringing the mail item to the logistics service provider. It is also possible that the logistics service provider picks up the mail item from the sender and/or technical means are used to deliver the mail item to the logistics service provider, such as a conveyor belt or a packing station. Given that the sender itself may bring the mail item to the logistics service provider or that the logistics service provider picks up the mail item from the sender, it is ensured that the mail item can no longer be seen or changed by unauthorized parties.

Continuing with such example(s), before the logistics service provider then delivers the mail item to the recipient according to example step g), the logistics service provider may first read the received signal out of the received postage indicium of the received mail item, in example step e). For the reading process, the logistics service provider may use a suitable reading device such as a camera or a scanner device, which preferably has a resolution of at least 5 megapixels.

In example step f), the logistics service provider may then compare the thusly read-out, received seal with the sender's seal that was transmitted in example step c). If the seals match, i.e., provided there is no difference between the transmitted seal and the read-out, received seal, then the mail item undoubtedly originates from the sender, and is therefore an “original”. In this case, the received postage indicium therefore matches the postage indicium that was generated in example step a) and was applied in example step b), and, therefore, so does the electronic seal embedded therein. Provided it is determined, however, that the received seal that was extracted from the received postage indicium does not match the seal transmitted in example step c), the logistics service provider can halt a delivery of the mail item to the recipient, for example can inform the sender and/or the recipient of the fraud, can destroy the mail item, or can return the mail item to the sender.

Further, in this example, provided the comparison of the read-out, received seal of the received mail item with the seal transmitted in advance in example step c) does not reveal a difference, the mail item is delivered to the recipient in step g), preferably by the logistics service provider. It is therefore ensured that unauthorized third parties cannot copy or manipulate the mail item during the delivery of the mail item by the logistics service provider to the recipient.

In example step h), the recipient can then detect the delivered postage indicium of the delivered mail item by means of the mobile reading device, for example by means of a smartphone or a corresponding application, and can then transfer said postage indicium to the logistics service provider in example step e). The transmission preferably takes place by means of an Internet connection, for example by means of a wired or wireless Internet connection. In other words, it may therefore be preferable that the recipient only detects the delivered postage indicium by means of the mobile reading device, and does not read and/or extract the delivered seal out of the delivered postage indicium. The reason therefor is that, according to the method, the logistics service provider reads the delivered seal out of the delivered postage indicium that was received by the recipient, in example step j).

Finally, in example step k), the logistics service provider may compare the thusly read-out, delivered seal, which was ultimately received by the recipient, with the seal transmitted by the sender in example step c). Provided the delivered seal matches the transmitted seal, the identity of the sender is ensured. In other words, the mail item has been delivered, undamaged, from the correct sender to the correct recipient. A corresponding confirmation may be electronically transmitted to the recipient by means of example step l), whereby the logistics service provider confirms the authenticity of the mail item to the recipient. In this case, the applied seal, the received seal, and the delivered seal all match. In such examples, he applied postage indicium, the received postage indicium, and the delivered postage indicium also match.

In the end, the recipient is ensured, via the method according to the invention, that the identity of the sender is correct and that the mail item has been transported, undamaged, between the sender and the recipient. As a precondition therefore, it goes without saying that the sender as well as the logistics service provider keep the seal secret from third parties, and that the seal is to be transmitted from the sender to the logistics service provider via a secure interface. In addition, it goes without saying that the mail item is not accessible to unauthorized third parties along the transport route from the sender to the recipient. Given that the postage indicium is designed to be machine-readable, the method can be automated particularly easily such that the seal can be read out and processed by a computer device in an automated manner by the logistics service provider and, likewise, can be detected by the recipient by means of the mobile reading device and can be forwarded to the logistics service provider in an automated manner. By means of the method under discussion, it is therefore possible to effectively prevent phishing by the mail item, since the recipient can easily check the authenticity of the mail item by reading in the delivered postage indicium.

According to a further example, the postage indicium may also include a piece of mail item information and/or franking information, and the method has the following :
e′) the logistics service provider reading a received piece of mail item information and/or franking information out of the received postage indicium of the received mail item,
f′) the logistics service provider comparing the received piece of mail item information and/or franking information with a stored piece of mail item information and/or franking information, and
g′) delivering the mail item to the recipient, provided the comparison carried out according to step f′) shows a match.

By means of this example, it may be possible for the logistics service provider to perform an additional check, before delivering the mail item to the recipient, to determine whether the mail item information and/or franking information are correct, and to thereby check, for example, whether the mail item has been sufficiently franked or if the franking is fraudulent. If this is not the case, the logistics service provider can inform the sender about the difference or the fraud. The stored piece of mail item information and/or franking information can be stored in a database, wherein it is also possible for the sender to transfer the piece of mail item information and/or franking information together with the seal to the logistics service provider in example step c). In such an example, the logistics service provider can then not only compare the read-out, received seal, but can also compare the previously received mail item information and/or franking information with the read-out, received mail item information and/or franking information.

According to a further example, the method may include the example step g″) of permitting the received bit of mail item information and/or franking information to be corrected in the event that the comparison carried out according to example step f′) does not show a match and the comparison carried out according to example step f) shows a match. Therefore, if the logistics service provider determines that the seal is not fraudulent, but the bit of mail item information and/or franking information is incorrect, for example the address of the recipient is erroneous or the mail item is insufficiently franked, the logistics service provider can make it possible for the sender to correct the discrepancy. For example, the logistics service provider can make a web site available to the sender, in which the sender can correct the recipient's address or submit an additional payment for the franking. Further, the mail item information may include an issuer's number, a franking date, a product number and/or a mail item number, and information on the recipient of the mail item.

According to, another example, the example methods may include the example step k′) of the logistics service provider electronically transmitting a bit of sender information on the mail item to the recipient, provided the method carried out according to example step j) shows a match. According to this example, the recipient is informed of a piece of sender information, for example an address of the sender, by the logistics service provider. The electronic transmission from the logistics service provider may take place on the mobile reading device, for example on a smartphone that belongs to the recipient. It is thereby possible to inform the recipient of a “correct” address of the sender.

In certain examples, the machine-readable postage indicium can have any configuration. According to a certain implementations, the machine-readable postage indicium may be configured as a matrix code, a bar code, a serial shipping container code, a EAN-UPC code, a ITF-14 code and/or as a data matrix code. The serial shipping container code may be configured according to the GS1-128 standard and the data matrix code is configured according to ISO/IEC 16022:2000. In the case of a configuration according to GS1, the postage indicium can be configured as a GS1 data matrix, which is also referred to as a data matrix code with GS1 data structure. By means of such a development, it may be possible to ensure particularly good machine-readability of the postage indicium, but also to ensure, via the use of one of the aforementioned standardizations, that the thusly configured postage indicium can be automatically detected by means of currently existing reading devices available to the logistics service provider.

According to a further implementations, the mobile reading device may be configured as a smartphone, a tablet PC, a laptop, a camera and/or an application. The reading device may be a camera for detecting the postage indicium, wherein, a correspondingly designed application on a smartphone may wirelessly transmit the thusly read-in postage indicium by means of an Internet connection configured on the smartphone to the logistics service provider. Since a plurality of smartphones are already equipped with a camera and an Internet connection these days, the method according to the innovations here can be implemented particularly easily by any number of recipients, in principle, in that the particular recipient only needs to load a corresponding application on his smartphone or, as an alternative, on his tablet PC. In this regard, the method can be implemented by the recipient straightforwardly.

The electronic seal can likewise have any type of design, although, according to a certain embodiments, the electronic seal may be designed as a symmetric key, as a one-time password and/or as a one-time password generated by means of an HMAC-based one-time password algorithm according to RFC 4226. Implementations may utilize or involve a one-time password, of particular advantage, which may a make it not necessary to exchange each seal individually for every specific mail item; instead, according to some methods, by means of the example step m), the seal can be exchanged between the sender and the logistics service provider by means of a Diffie-Hellman-Keppler method, for example, i.e. the seal can be exchanged for an entire group of mail items, for example one specific delivery order from a sender.

In that case, i.e. regardless of whether a symmetric secret or a one-time password is selected, the generation of the secret, i.e. the seal, should be sufficiently random such that the secret cannot be predicted on the basis of any other environmental data, in particular such as any other information contained in the postage indicium. The aforementioned RFC 4226, “Requests for Comments”, is a fixed definition entitled “an HMAC-based one-time password algorithm”, the code of which is based on a cryptographic hash function. The abbreviation HMAC stands for “hash-based message authentication code”. A person skilled in the art will find a definition of this algorithm in the RFC 4226, which was enacted by the Internet Engineering Task Force in December 2005.

According to certain implementations, the methods may include the example step n) of the logistics service provider electronically transmitting a confirmation of the authenticity of the mail item to the recipient, provided the method carried out according to example step k) shows a match. The sender can also be informed by means of such a confirmation that a mail item has been received safely and undamaged by the “correct” recipient.

The innovations are also described in greater detail in the following with reference to the attached drawings and preferred embodiments.

In the drawings

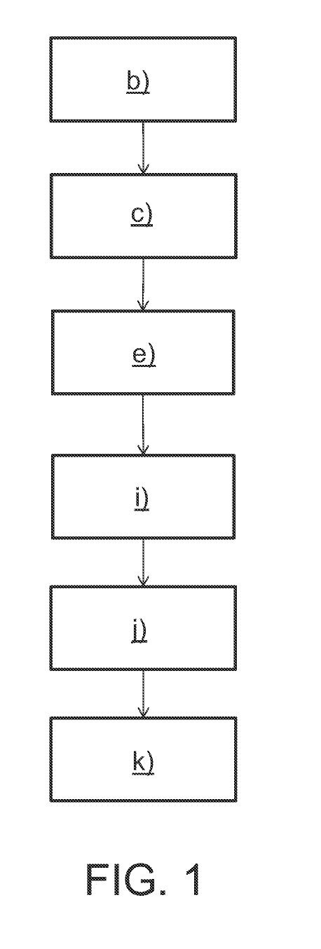

FIG. 1 shows an example method for checking an authentication of a sender of a mail item according to certain exemplary embodiments of the innovations herein, in the form of a flow chart,

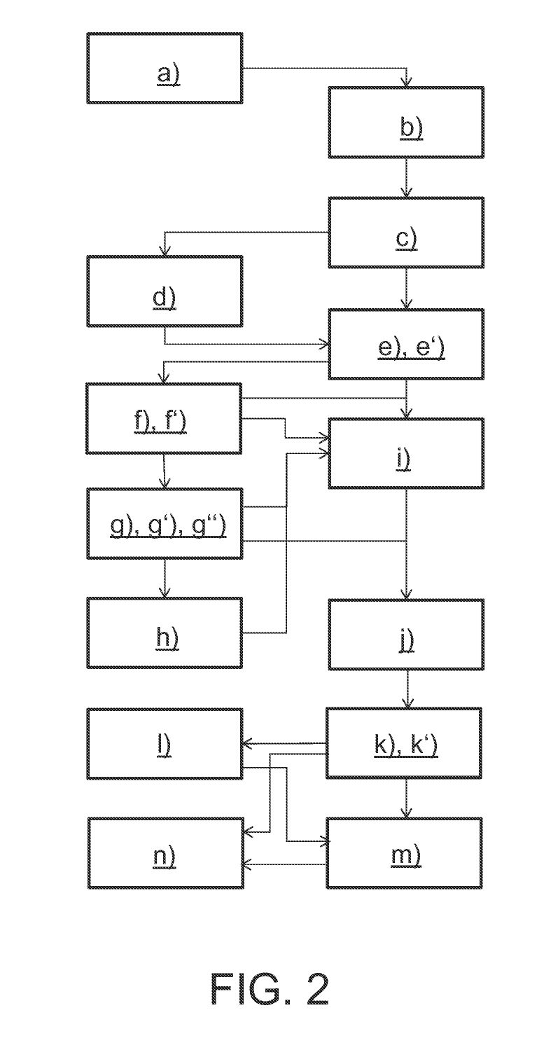

FIG. 2 shows an example method according to FIG. 1, comprising additional steps, each of which is optional, also in the form of a flow chart, and

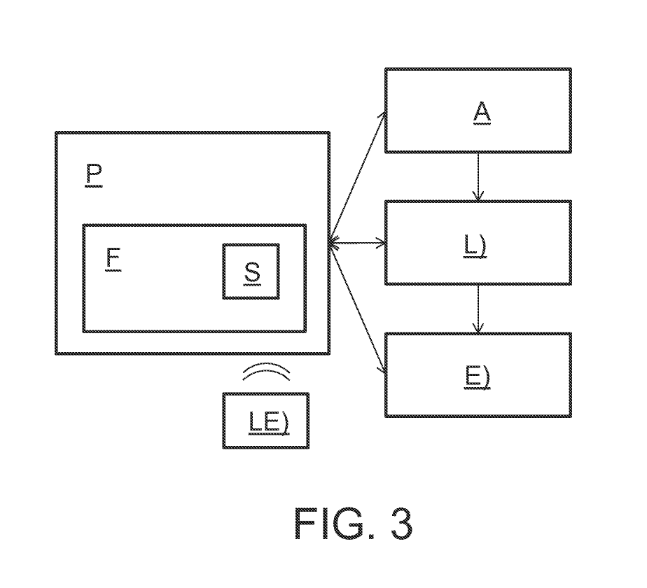

FIG. 3 shows an example schematic depiction of the sender, a logistics service provider, a recipient, and the mail item according to the certain exemplary embodiments.

FIG. 1 shows, in the form of an example flow chart, an example method according to the innovative aspects described here for checking an authentication of a sender A of a mail item P, wherein FIG. 2 shows the method depicted in FIG. 1 having additional, optional steps. FIG. 3 shows, in an example schematic view, the mail item P and the sender A involved in the method, a logistics service provider L involved in the method and, finally, a recipient E involved in the method.

In example step b), the sender A first applies a machine-readable postage indicium F having an embedded electronic seal S onto the mail item P. The postage indicium F is configured as a matrix code, wherein the electronic seal S is a one-time password, which was generated by means of an HMAC-based one-time password algorithm according to RFC 4226. The mail item P is a letter, wherein a package or any other type of transportable good would also be possible. “Machine-readable” means that the thusly configured postage indicium F can be read in an automated manner by means of an electronic detection device belonging to the logistics service provider L, for example by means of a camera.

In the subsequent example step c), the sender A electronically transmits the seal S to the logistics service provider L, by means of an Internet connection in the present case. Next, in example step e), the logistics service provider L reads a received seal S out of a received postage indicium F on the mail item P that was received in the meantime by the logistics service provider L. Provided the received postage indicium F is the postage indicium F that was applied onto the mail item P in example step b), it goes without saying that the received postage indicium F is the applied postage indicium F and, likewise, the received seal S is the seal S that was electronically transmitted in example step c).

Continuing with the example, once the logistics service provider L has delivered the mail item P to the recipient E, the recipient E transmits—in example step i)—a delivered postage indicium F of the mail item P to the logistics service provider L that was detected by means of a mobile reading device LE. In example step j), the logistics service provider L then reads a delivered seal S out of the thusly received, delivered postage indicium F and compares said seal, in step k), with the seal S that was transmitted in example step c). Provided the delivered seal S matches the transmitted seal S, the authenticity of the sender A of the mail item P is ensured. In other words, this means that the mail item P has been sent, undamaged, by the sender A to the recipient E.

FIG. 2 shows further optional steps of the method according to the invention. According to example step a), the postage indicium F comprising the embedded seal S is initially generated by the sender A, for example by means of a computer device, such that the matrix code can be printed onto the mail item in example step b). According to step d), the mail item P is delivered to the logistics service provider L, either by the sender A or by the logistics service provider L if said logistics service provider picks up the mail item P from the sender A.

In order to then determine whether the read-out, received seal S of the mail item P received by the logistics service provider L matches the seal S that was previously electronically transmitted, in example step c), the logistics service provider L compares the received seal S with the transmitted seal S in example step f). The logistics service provider L can thereby initially determine whether the mail item P is an “original” from the sender A. If this is the case, the logistics service provider L delivers the mail item P to the recipient E in example step g).

In addition to the seal S, the postage indicium F can also comprise a piece of mail item information and/or franking information, for example an address of the recipient E and a franking. Example steps e′), f) and g′) are provided for this purpose, by means of which a received piece of mail item information and/or franking information is initially read out of the received postage indicium F, which is then compared with a stored piece of mail item information and/or franking information in example step f). It can thereby be determined whether the mail item P has sufficient franking or whether the address of the recipient E is correct.

Provided the comparison shows a match, the mail item P is delivered to the recipient E in example step g′). It is conceivable, however, that the check of the seal S confirms that the seal S is correct, but the comparison of the received piece of mail item information and/or franking information with the previously stored piece of mail item information and/or franking information shows a deviation, for example if the sender A has provided the wrong address for the recipient E or if the franking is insufficient. In this case, it is possible to correct the received piece of mail item information and/or franking information, in step g″). To this end, the logistics service provider L makes a web site available to the sender A, in which the sender A can correct a potential insufficient franking.

In example step h), the recipient E detects the delivered postage indicium F of the delivered mail item P by means of the mobile reading device LE. The reading device LE is configured as a smartphone on which a corresponding application is installed. The postage indicium F is detected by the camera of the smartphone and is transmitted to a server of the logistics service provider L via an Internet connection by means of the smartphone. In other words, the recipient E may detect the delivered postage indicium F of the delivered mail item P by means of his smartphone, but the recipient E is unable to evaluate the thusly read-out postage indicium F. Instead, in example step j), the logistics service provider L reads the delivered seal S out of the delivered postage indicium F that was received from the recipient E and, in example step k), compares this with the seal S that was previously received, in example step c).

Provided the comparison shows a match, the logistics service provider L electronically transmits a corresponding confirmation of the authenticity of the mail item P to the recipient E, in example step l). The recipient E can therefore rest assured that the mail item P was delivered by none other than the logistics service provider L, thereby confirming the origin as well as the undamaged state of the contents of the mail item P.

The electronic seal S, which is configured as a one-time password, is known only to the sender A and the logistics service provider L, wherein the seal S is exchanged, in example step m), by means of a Diffie-Hellman-Keppler method. This has the advantage that each seal S does not need to be exchanged individually for a specific mail item P, but rather that an exchange can take place for an entire group of mail items P.

Finally, according to example step n), it is also possible for the logistics service provider L to confirm with the sender A that the mail item P was delivered, provided the comparison of the delivered seal S confirms a match with the seal S that was transmitted in example step c). Therefore, the sender A also knows that the mail item P has been successfully delivered to the recipient E.

By means of the example methods according to the innovative aspects here, the recipient E may receive confirmation from the logistics service provider L of the authenticity of the sender A of the mail item P without the receiver E needing to know the identity of the sender A. The logistics service provider L can guarantee, by means of the described method, that the mail item P and, therefore, the contents of the mail item P, have been delivered, undamaged, from the “correct” sender A to the “correct” recipient E without the logistics service provider L needing to know the contents of the mail item P. Finally, the logistics service provider L can confirm, with the sender A, the identity of the recipient E without the need for the sender A to maintain his own complex system.

Implementations and Other Nuances

The innovations herein may be implemented via one or more components, systems, servers, appliances, other subcomponents, or distributed between such elements. When implemented as a system, such system may comprise, inter alia, components such as software modules, general-purpose CPU, RAM, etc. found in general-purpose computers, and/or FPGAs and/or ASICs found in more specialized computing devices. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules or other data embodied in a tangible manner/media. No such media herein encompasses/comprises transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission. Also, the modules can be implemented as hardware logic circuitry implementing the functions encompassed by the innovations herein. Finally, the modules can be implemented using special purpose instructions (SIMD instructions), field programmable logic arrays or mixtures of those or other suitable elements which provide the desired level performance and cost.

As disclosed herein, features consistent with the present inventions may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though computer readable media herein does not encompass/include transitory media.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the present inventions have been specifically described herein, it will be apparent to those skilled in the art to which the inventions pertain that variations and modifications of the various implementations shown and described herein may be made without departing from the spirit and scope of the inventions. Accordingly, it is intended that the inventions be limited only to the extent required by the applicable rules of law.

### LIST OF REFERENCE CHARACTERS

sender A
logistics service provider L
recipient E
mail item P
postage indicium F
seal S
reading device LE

1. A method for verifying an authentication of a sender of a mail item, comprising:
a) generating, via the sender, a machine-readable postage indicium using a computer-implemented method, the postage indicium being configured as a matrix code, a bar code, a serial shipping container code, a EAN-UPC Code, a ITF-14 code and/or a data matrix code, wherein an electronic seal, as an electronic secret, and a piece of unambiguous mail item information assigned to the particular mail item are embedded in the postage indicium, and wherein the electronic seal is designed as an electronic secret encoded with a symmetric key, as a one-time password as electronic secret, and/or as a one-time password as electronic secret, which is generated by means of an HMAC-based one-time password algorithm according to RFC 4226,
b) applying and/or printing, via the sender, the machine-readable postage indicium having the embedded electronic seal onto the mail item,
c) electronically transmitting, via the sender, the electronic seal to a logistics service provider by means of an Internet connection,
d) delivering, via the sender, the mail item to the logistics service provider,
e) reading, via the logistics service provider, a received seal out of a received postage indicium of the mail item that was received by the logistics service provider, by means of a first reading device, which is provided as a smartphone, a tablet PC, a laptop, a camera and/or as an application,
f) comparing, via the logistics service provider, the received seal with the transmitted seal, using a computer-implemented method,
g) delivering, via the logistics service provider, the mail item to the recipient, provided the comparing of step f) shows a match,
h) detecting, via the recipient, the delivered postage indicium of the mail item delivered to the recipient, by means of a mobile reading device, which is provided as a smartphone, a tablet PC, a laptop, a camera and/or an application,
i) transferring, via the recipient, a delivered postage indicium, which was detected by the recipient of the mail item using the mobile reading device, to the logistics service provider via an Internet connection,
j) reading, via the logistics service provider, a delivered seal out of the received, delivered postage indicium using a computer-implemented method, and
k) comparing, via the logistics service provider, the received seal with the transmitted seal, using a computer-implemented method,
l) electronically transmitting, via the logistics service provider, a confirmation of the authenticity of the mail item to the recipient using an Internet connection, provided the comparing of step k) shows a match.

2. The method according to claim 1, wherein the postage indicium additionally comprises a piece of franking information, the method further comprising:
reading, via the logistics service provider, a received piece of mail item information and/or franking information out of the received postage indicium of the received mail item,
performing a comparison, via the logistics service provider, of the received piece of mail item information and/or franking information with a stored piece of mail item information and/or franking information, and
delivering the mail item to the recipient, provided the performing a comparison shows a match.

3. The method according to claim 2, further comprising:
permitting the received bit of mail item information and/or franking information to be corrected in the event that the performing a comparison does not show a match and the comparing of step f) shows a match.

4. The method according to claim 1, further comprising:
electronically transmitting, via the logistics service provider, a piece of sender information on the mail item to the recipient via an Internet connection, provided the comparing of step k) shows a match.

5. The method according to claim claims, further comprising:
electronically exchanging the seal between the sender and the logistics service provider using a Diffie-Hellman-Keppler method, via an Internet connection.

6. The method according to claim 1, further comprising:
electronically transmitting, via the logistics service provider, a confirmation of the delivery of the mail item to the sender by means of an Internet connection, provided the comparing of step k) shows a match.

7. The method according to claim 2 further comprising:
electronically transmitting, via the logistics service provider, a piece of sender information on the mail item to the recipient via an Internet connection, provided the comparing of step k) shows a match.

8. The method according to claim 7, further comprising:
electronically exchanging the seal between the sender and the logistics service provider using a Diffie-Hellman-Keppler method, via an Internet connection.

9. The method according to claim 7, further comprising:
electronically transmitting, via the logistics service provider, a confirmation of the delivery of the mail item to the sender by means of an Internet connection, provided the comparing of step k) shows a match.

10. The method according to claim 9, further comprising:
electronically exchanging the seal between the sender and the logistics service provider using a Diffie-Hellman-Keppler method, via an Internet connection.

11. The method according to claim 2, further comprising:
electronically exchanging the seal between the sender and the logistics service provider using a Diffie-Hellman-Keppler method, via an Internet connection.

12. The method according to claim 2, further comprising:
electronically transmitting, via the logistics service provider, a confirmation of the delivery of the mail item to the sender by means of an Internet connection, provided the comparing of step k) shows a match.

13. The method according to claim 3 further comprising:
electronically transmitting, via the logistics service provider, a piece of sender information on the mail item to the recipient via an Internet connection, provided the comparing of step k) shows a match.

14. The method according to claim 13, further comprising:
electronically transmitting, via the logistics service provider, a confirmation of the delivery of the mail item to the sender by means of an Internet connection, provided the comparing of step k) shows a match.

15. The method according to claim 3, further comprising:
electronically exchanging the seal between the sender and the logistics service provider using a Diffie-Hellman-Keppler method, via an Internet connection.

16. The method according to claim 3, further comprising:
electronically transmitting, via the logistics service provider, a confirmation of the delivery of the mail item to the sender by means of an Internet connection, provided the comparing of step k) shows a match.

17. The method according to claim 4, further comprising:
electronically exchanging the seal between the sender and the logistics service provider using a Diffie-Hellman-Keppler method, via an Internet connection.

18. The method according to claim 17, further comprising:
electronically transmitting, via the logistics service provider, a confirmation of the delivery of the mail item to the sender by means of an Internet connection, provided the comparing of step k) shows a match.

19. The method according to claim 4, further comprising:
electronically transmitting, via the logistics service provider, a confirmation of the delivery of the mail item to the sender by means of an Internet connection, provided the comparing of step k) shows a match.

20. The method according to claim 5, further comprising:
electronically transmitting, via the logistics service provider, a confirmation of the delivery of the mail item to the sender by means of an Internet connection, provided the comparing of step k) shows a match.
